(19) United States
(12) Patent Application Publication
(10) Pub. No.: US 2026/0182535 A1
(43) Pub. Date: Jul. 2, 2026

(54) 3D MESH FABRIC PET BED WITH ENHANCED AIR PERMEABILITY

(71) Applicant: Suzhou Renrui Network Technology Co., Ltd, Changshu (CN)

(72) Inventor: Minghua Wen, Suzhou (CN)

(21) Appl. No.: 19/552,057

(22) Filed: Feb. 27, 2026

(51) Int. Cl. A01K 1/035

(52) U.S. Cl. CPC A01K 1/0353

(57) ABSTRACT

Provided is a 3D (Three-dimensional) mesh fabric pet bed with enhanced air permeability, belonging to the technical field of pet beds. The pet bed includes a first 3D mesh fabric mattress assembly, a second 3D mesh fabric mattress assembly, and a bracket assembly. A first 3D mesh fabric mattress assembly and a second 3D mesh fabric mattress assembly are provided. The first 3D mesh fabric mattress assembly and the second 3D mesh fabric mattress assembly are disposed in an up-down overlapping structure, and the dual-layer 3D mesh fabric mattress assembly can enhance overall support strength while maintaining excellent air permeability.

### TECHNICAL FIELD

The present disclosure belongs to the technical field of pet beds, and specifically, to a 3D mesh fabric pet bed with enhanced air permeability.

### BACKGROUND

A pet bed is a special-purpose utensil designed for pets to rest and sleep on, which is intended to provide a comfortable and safe resting environment for the pets.

A conventional mattress for the pet bed is made of ordinary polyester fiber or sponge, and such a structure has the following drawbacks.

1. Long-term use may result in loss of elasticity, failing to provide effective support.

2. The mattress has poor air permeability and is prone to bacterial growth.

3. A bed frame and the mattress are generally of an integrated structure, making it rather difficult to clean the mattress.

In view of this, a 3D mesh fabric pet bed with enhanced air permeability is designed to solve the foregoing problem.

### SUMMARY

To solve the problem proposed in the foregoing background. The present disclosure provides a 3D mesh fabric pet bed with enhanced air permeability, which can enhance support strength while maintaining air permeability, and facilitate cleaning while making the mounting and dismounting convenient.

To achieve the objective described above, the present disclosure provides the following technical solutions. A 3D mesh fabric pet bed with enhanced air permeability includes:

a first 3D mesh fabric mattress assembly, which is mounted on the topmost position to improve air permeability while enhancing support performance;

a second 3D mesh fabric mattress assembly, which is mounted below the first 3D mesh fabric mattress assembly and attached to the first 3D mesh fabric mattress assembly to enhance air permeability while cooperating with the first 3D mesh fabric mattress assembly for supporting; and

a bracket assembly, which is mounted between the first 3D mesh fabric mattress assembly, the second 3D mesh fabric mattress assembly and the ground and cooperate with the first 3D mesh fabric mattress assembly and the second 3D mesh fabric mattress assembly to form a pet bed;

the bracket assembly includes a first mattress mounting bracket assembly, a second mattress mounting bracket assembly, an adsorption assembly, and a synchronous drive assembly; the first mattress mounting bracket assembly is mounted between the first 3D mesh fabric mattress assembly and the ground, the second mattress mounting bracket assembly is mounted between the second 3D mesh fabric mattress assembly and the ground, the adsorption assembly is mounted on the ground, and the synchronous drive assembly is mounted between the first mattress mounting bracket assembly, the second mattress mounting bracket assembly, and the adsorption assembly to drive the first mattress mounting bracket assembly, the second mattress mounting bracket assembly, and the adsorption assembly to complete mounting and adsorption at the same time.

Further, the first 3D mesh fabric mattress assembly includes an upper 3D mesh fabric mattress, upper connecting sleeves are fixedly connected to both ends of the upper 3D mesh fabric mattress by sewing, respectively, and the two upper connecting sleeves are disposed symmetrically.

Further, the second 3D mesh fabric mattress assembly includes a lower 3D mesh fabric mattress disposed below the upper 3D mesh fabric mattress, lower connecting sleeves are fixedly connected to both ends of the lower 3D mesh fabric mattress by sewing, respectively, and the two lower connecting sleeves are disposed symmetrically and perpendicular to the lower 3D mesh fabric mattress.

Further, the first mattress mounting bracket assembly includes two upper support pipes movably nested inside the two upper connecting sleeves and four main brackets disposed at both ends of the two upper support pipes, an upper support arm is fixedly connected to an end wall, facing the upper support pipe, of the main bracket, an upper accommodating groove communicating with the outside is formed in a side, facing the upper support pipe, of the upper support arm, and an upper plug-in bracket that is provided with an internal threaded hole and inserted into the upper support pipe is slidably disposed inside the upper accommodating groove.

Further, the second mattress mounting bracket assembly includes two lower support pipes movably nested inside the two lower connecting sleeves and four lower support arms fixedly connected to end walls, facing the lower support pipes, of the four main brackets, a lower accommodating groove communicating with the outside is formed in a side, facing the lower support pipe, of the lower support arm, and a lower plug-in bracket that is provided with an internal threaded hole and inserted into the lower support pipe is slidably disposed inside the lower accommodating groove.

Further, the adsorption assembly includes a support groove formed in the main bracket, an extrusion bracket with an internal threaded hole is disposed in the support groove, and a suction cup is fixedly connected to a bottom end of the extrusion bracket with the internal threaded hole.

Further, the synchronous drive assembly includes a rotary knob disposed on the main bracket, two drive grooves respectively formed inside the upper support arm and the lower support arm on sides away from the upper accommodating groove and the lower accommodating groove, and multiple limiting grooves equidistantly formed along a circumferential direction on an inner sidewall that is of the upper support arm and that faces the upper accommodating groove, an inner sidewall that is of the lower support arm and that faces the lower accommodating groove, and an inner sidewall of the main bracket; a driving screw is fixedly connected to a bottom end of the rotary knob, a bottom end of the driving screw penetrates through the main bracket to extend into the support groove and to be rotatably connected to the main bracket; the driving screw is fixedly sleeved with a driving bevel gear, and the bottom end of the driving screw is threaded to the extrusion bracket with the internal threaded hole; a driven screw is disposed inside the drive groove, and an end wall, close to the driving bevel gear, of the driven screw is fixedly sleeved with a driven bevel gear, and the driven bevel gear meshes with the driving bevel gear; the other end of the driven screw penetrates through the upper support arm and the lower support arm and extends into the upper accommodating groove and the lower accommodating groove to be threaded to the upper plug-in bracket with the internal threaded hole and the lower plug-in bracket with the internal threaded hole; the driven screw is rotatably connected to the upper support arm and the lower support arm; and a limiting block is movably embedded in the limiting groove, and multiple limiting blocks are fixedly connected to the upper plug-in bracket with the internal threaded hole, the lower plug-in bracket with the internal threaded hole, and the extrusion bracket with the internal threaded hole, respectively.

Further, end walls, away from the main bracket, of the upper support arm and the lower support arm are fixedly sleeved with limiting rings, respectively, and the limiting rings abut against end walls of the upper connecting sleeve and the lower connecting sleeve, respectively.

Compared with the prior art, the present disclosure has beneficial effects as follows.

1. According to the present disclosure, a first 3D mesh fabric mattress assembly, a second 3D mesh fabric mattress assembly are provided. The first 3D mesh fabric mattress assembly and the second 3D mesh fabric mattress assembly are disposed in an up-down overlapping structure, and the dual-layer 3D mesh fabric mattress assembly can enhance overall support strength while maintaining excellent air permeability.

2. According to the present disclosure, the first 3D mesh fabric mattress assembly and the second 3D mesh fabric mattress assembly are assembled through a bracket assembly, the bracket assembly is composed of the first mattress mounting bracket assembly, the second mattress mounting bracket assembly, an adsorption assembly, and a synchronous drive assembly, which is a detachable structure that facilitates positioning, mounting, and dismounting. The cleaning convenience of the mattress is improved, and the connecting strength with the ground can be improved at the same time to avoid the occurrence of rollover and improve use safety.

### BRIEF DESCRIPTION OF THE DRAWINGS

FIG. 1 is a perspective diagram according to the present disclosure;

FIG. 2 is an exploded view according to the present disclosure;

FIG. 3 is a vertical sectional view of a bracket assembly according to the present disclosure;

FIG. 4 is a cross sectional view of a bracket assembly according to the present disclosure;

FIG. 5 is a vertical sectional view of a bracket assembly according to the present disclosure from another perspective.

In the drawings: 101: upper 3D mesh fabric mattress; 102: upper connecting sleeve;

201: lower 3D mesh fabric mattress; 202: lower connecting sleeve;

301: upper support pipe; 302: upper plug-in bracket with internal threaded hole; 303: main bracket; 304: upper support arm; 305: upper accommodating groove;

401: lower support pipe; 402: lower plug-in bracket with internal threaded hole; 403: lower support arm; 404: lower accommodating groove;

501: support groove; 502: extrusion bracket with internal threaded hole; 503: suction cup;

601: driving bevel gear; 602: driven bevel gear; 603: limiting groove; 604: limiting block; 605: drive groove; 606: driven screw; 607: rotary knob; 608: driving screw;

701: limiting ring.

### DETAILED DESCRIPTION OF THE EMBODIMENTS

The following clearly and completely describes the technical solutions in the embodiments of the present disclosure with reference to the accompanying drawings in the embodiments of the present disclosure. Apparently, the described embodiments are merely a part rather than all of the embodiments of the present disclosure. Based on the embodiments in the present disclosure, all other embodiments obtained by those of ordinary skill in the art without making creative labor fall within the scope of protection of the present disclosure.

The present disclosure provides the following technical solutions. A 3D mesh fabric pet bed with enhanced air permeability includes:

a first 3D mesh fabric mattress assembly, which is mounted on the topmost position to improve air permeability while enhancing support performance;

a second 3D mesh fabric mattress assembly, which is mounted below the first 3D mesh fabric mattress assembly and attached to the first 3D mesh fabric mattress assembly to enhance air permeability while cooperating with the first 3D mesh fabric mattress assembly for supporting; and

a bracket assembly, which is mounted between the first 3D mesh fabric mattress assembly, the second 3D mesh fabric mattress assembly and the ground and cooperate with the first 3D mesh fabric mattress assembly and the second 3D mesh fabric mattress assembly to form a pet bed.

The bracket assembly includes a first mattress mounting bracket assembly, a second mattress mounting bracket assembly, an adsorption assembly, and a synchronous drive assembly. The first mattress mounting bracket assembly is mounted between the first 3D mesh fabric mattress assembly and the ground, the second mattress mounting bracket assembly is mounted between the second 3D mesh fabric mattress assembly and the ground, the adsorption assembly is mounted on the ground, and the synchronous drive assembly is mounted between the first mattress mounting bracket assembly, the second mattress mounting bracket assembly, and the adsorption assembly to drive the first mattress mounting bracket assembly, the second mattress mounting bracket assembly, and the adsorption assembly to complete mounting and adsorption at the same time.

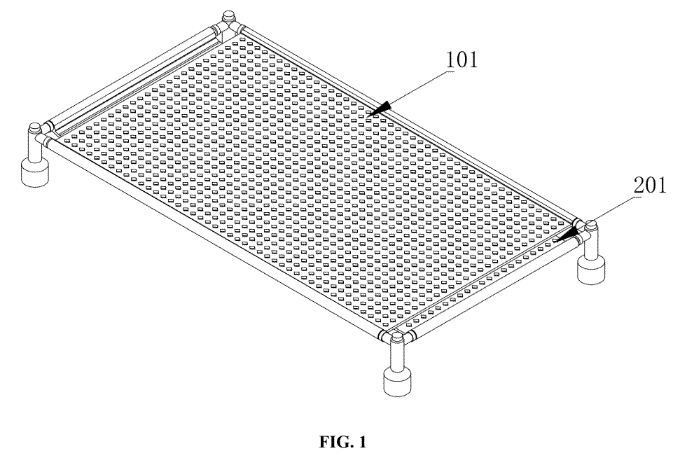

With reference to FIG. 1 to FIG. 5, the 3D mesh fabric pet bed with enhanced air permeability is composed of a bracket assembly, a first 3D mesh fabric mattress assembly, and a second 3D mesh fabric mattress assembly.

The first 3D mesh fabric mattress assembly and the second 3D mesh fabric mattress assembly are disposed in an up-down overlapping structure, and the dual-layer 3D mesh fabric mattress assembly can enhance overall support strength while maintaining excellent air permeability. In addition, the mattress assembly can be cleaned independently.

The bracket assembly is composed of a first mattress mounting bracket assembly, a second mattress mounting bracket assembly, an adsorption assembly, and a synchronous drive assembly.

The synchronous drive assembly can simultaneously drive the first mattress mounting bracket assembly and the second mattress mounting bracket assembly for cooperative mounting of the first 3D mesh fabric mattress assembly and the second 3D mesh fabric mattress assembly, and drive the adsorption assembly to firmly adsorb onto the ground, so that the connecting strength can be enhanced while facilitating positioning and mounting, the occurrence of rollover is avoided, and the use safety is improved.

Specifically, the first 3D mesh fabric mattress assembly includes an upper 3D mesh fabric mattress 101, upper connecting sleeves 102 are fixedly connected to both ends of the upper 3D mesh fabric mattress 101 by sewing, respectively, and the two upper connecting sleeves 102 are disposed symmetrically.

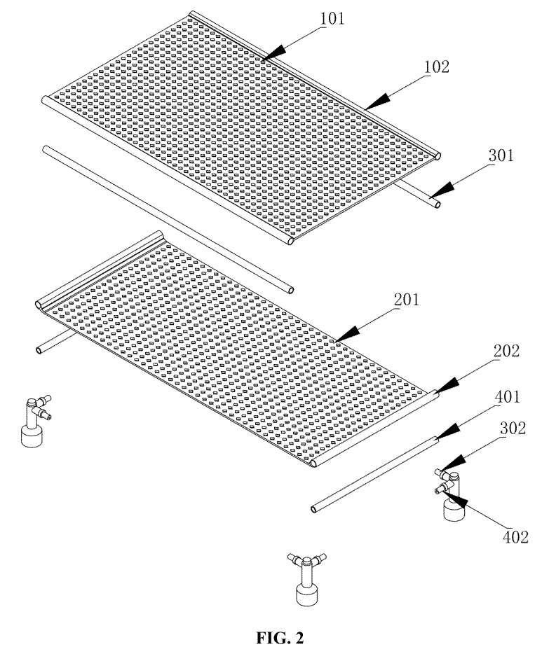

With reference to FIG. 1 and FIG. 2, the first 3D mesh fabric mattress assembly is composed of the upper 3D mesh fabric mattress 101 sewn from a single layer or multiple layers of 3D mesh fabric.

The two upper connecting sleeves 102 at both ends of the upper 3D mesh fabric mattress 101 provide connecting points.

Specifically, the second 3D mesh fabric mattress assembly includes a lower 3D mesh fabric mattress 201 disposed below the upper 3D mesh fabric mattress 101, lower connecting sleeve 202 are fixedly connected to both ends of the lower 3D mesh fabric mattress 201 by sewing, respectively, and the two lower connecting sleeves 202 are disposed symmetrically and perpendicular to the lower 3D mesh fabric mattress 201.

With reference to FIG. 1 and FIG. 2, the second 3D mesh fabric mattress assembly is composed of the lower 3D mesh fabric mattress 201 sewn from a single layer or multiple layers of 3D mesh fabric.

The two lower connecting sleeves 202 at both ends of the lower 3D mesh fabric mattress 201 provide connecting points.

An up-down overlapping arrangement of the upper 3D mesh fabric mattress 101 and the lower 3D mesh fabric mattress can enhance overall support strength while maintaining excellent air permeability. In addition, the mattress assembly can be cleaned independently.

Specifically, the first mattress mounting bracket assembly includes two upper support pipes 301 movably nested inside the two upper connecting sleeves 102 and four main brackets 303 disposed at both ends of the two upper support pipes 301, an upper support arm 304 is fixedly connected to an end wall, facing the upper support pipe 301, of the main bracket 303, an upper accommodating groove 305 communicating with the outside is formed in a side, facing the upper support pipe 301, of the upper support arm 304, and an upper plug-in bracket 302 that is provided with an internal threaded hole and inserted into the upper support pipe 301 is slidably disposed inside the upper accommodating groove 305.

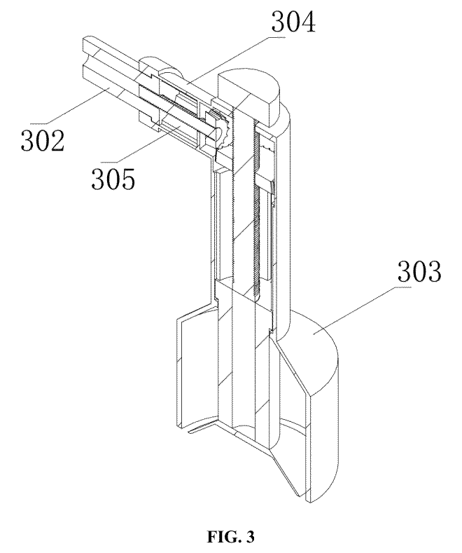

With reference to FIG. 2 and FIG. 3, the first mattress mounting bracket assembly is formed by inserting the two upper support pipes 301 into the two upper connecting sleeves 102, and four upper plug-in brackets 302 with internal threaded holes at both ends of the two upper support pipes 301 are inserted into the two upper support pipes 301 to complete the mounting of the upper 3D mesh fabric mattress 101.

Specifically, the second mattress mounting bracket assembly includes two lower support pipes 401 movably nested inside the two lower connecting sleeves 202 and four lower support arms 403 fixedly connected to end walls, facing the lower support pipes 401, of the four main brackets 303, a lower accommodating groove 404 communicating with the outside is formed in a side, facing the lower support pipe 401, of the lower support arm 403, and a lower plug-in bracket 402 that is provided with an internal threaded hole and inserted into the lower support pipe 401 is slidably disposed inside the lower accommodating groove 404.

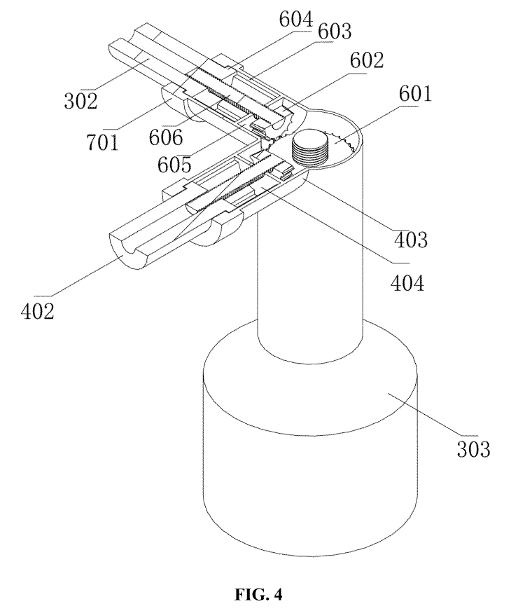

With reference to FIG. 2 and FIG. 4, the second mattress mounting bracket assembly is formed by inserting the two lower support pipes 401 into the two lower connecting sleeves 202, and four lower plug-in brackets 402 with internal threaded holes at both ends of the two lower support pipes 401 are inserted into the two lower support pipes 401 to complete the mounting of the lower 3D mesh fabric mattress 201.

Specifically, the adsorption assembly includes support groove 501 formed in the main bracket 303, an extrusion bracket 502 with an internal threaded hole is disposed in the support groove 501, and a suction cup 503 is fixedly connected to a bottom end of the extrusion bracket 502 with the internal threaded hole.

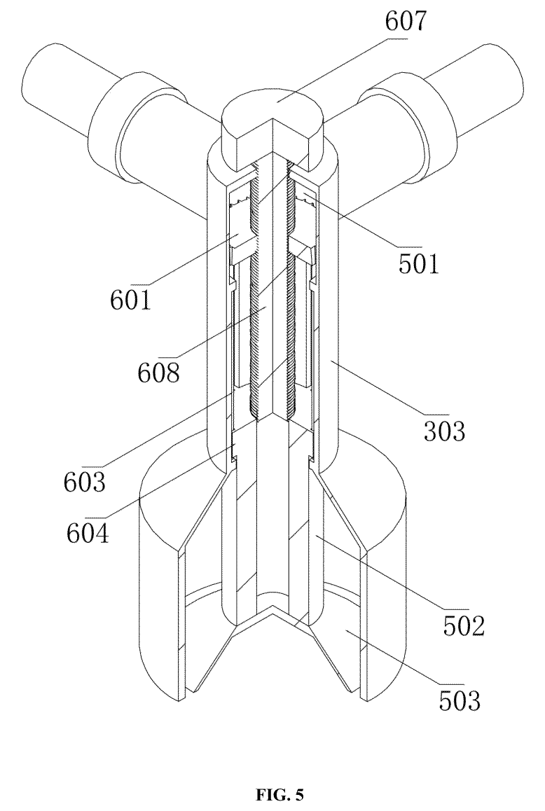

With reference to FIG. 5, the adsorption assembly drives the suction cup 503 to move downward through the downward-moving extrusion bracket (502) with the internal threaded hole, and the downward-moving suction cup 503 adsorbs onto the ground to complete the adsorption.

Specifically, the synchronous drive assembly includes a rotary knob 607 disposed on the main bracket 303, two drive grooves 605 respectively formed inside the upper support arm 304 and the lower support arm 403 on sides away from the upper accommodating groove 305 and the lower accommodating groove 404, and multiple limiting grooves 603 equidistantly formed along a circumferential direction on an inner sidewall that is of the upper support arm 304 and that faces the upper accommodating groove 305, an inner sidewall that is of the lower support arm 403 and that faces the lower accommodating groove 404, and an inner sidewall of the main bracket 303; a driving screw 608 is fixedly connected to a bottom end of the rotary knob 607, a bottom end of the driving screw 608 penetrates through the main bracket 303 to extend into the support groove 501 and to be rotatably connected to the main bracket 303, and the driving screw 608 is connected to a penetrating section of the main bracket 303 through a bearing; the driving screw 608 is fixedly sleeved with a driving bevel gear 601, and the bottom end of the driving screw 608 is threaded to the extrusion bracket 502 with the internal threaded hole; a driven screw 606 is disposed inside the drive groove 605, and an end wall, close to the driving bevel gear 601, of the driven screw 606 is fixedly sleeved with a driven bevel gear 602, and the driven bevel gear 602 meshes with the driving bevel gear 601; the other end of the driven screw 606 penetrates through the upper support arm 304 and the lower support arm 403 and then extends into the upper accommodating groove 305 and the lower accommodating groove 404 to be threaded to the upper plug-in bracket 302 with the internal threaded hole and the lower plug-in bracket 402 with the internal threaded hole; the driven screw 606 is rotatably connected to the upper support arm 304 and the lower support arm 403, and the driven screw rod 606 is rotatably connected with penetrating sections of the upper support arm 304 and the lower support arm 403 through bearings; a limiting block 604 is movably embedded in the limiting groove 603, and multiple limiting blocks 604 are fixedly connected to the upper plug-in bracket 302 with the internal threaded hole, the lower plug-in bracket 402 with the internal threaded hole, and the extrusion bracket 502 with the internal threaded hole, respectively.

With reference to FIG. 4 and FIG. 5, the synchronous driving assembly operates by rotating the rotary knob 607; the rotary knob 607 drives the driving screw 608 to rotate, and the driving screw 608 drives the driving bevel gear 601 to rotate. The driving bevel gear 601 drives two driven bevel gears 602 in meshed connection to rotate, and the two driven bevel gears 602 drive the two driven screws 606 to rotate. During the rotation of the two driven screws 606, due to the limiting effect of the multiple limiting blocks 604 in the multiple limiting grooves 603, the upper plug-in bracket 302 with the internal threaded hole and the lower plug-in bracket 402 with the internal threaded hole move on the two driven screws 606 toward directions close to the upper support pipe 301 and the lower support pipe 401, and are inserted into the upper support pipe 301 and the lower support pipe 401, respectively. During the rotation of the driving screw 608, due to the limiting effect of the multiple limiting blocks 604 in the multiple limiting grooves 603, the extrusion bracket 502 with the internal threaded hole moves downward on the driving screw 608 to drive the suction cup 503 to move downward to adsorb onto the ground, thereby completing synchronous drive of mounting and adsorption.

Specifically, end walls, away from the main bracket 303, of the upper support arm 304 and the lower support arm 403 are fixedly sleeved with limiting rings 701, respectively, and the limiting rings 701 abut against end walls of the upper connecting sleeve 102 and the lower connecting sleeve 202, respectively.

With reference to FIG. 4, the limiting rings 701 abut against the upper connecting sleeve 102 and the lower connecting sleeve 202 for position limiting, thereby preventing the upper connecting sleeve 102 and the lower connecting sleeve 202 from sliding freely on the upper support pipe 301 and the lower support pipe 401.

The working principle of the present disclosure is as follows.

A main bracket A is placed on the ground, the rotary knob 607 is rotated to drive the driving screw 608 to rotate, and the driving screw 608 drives the driving bevel gear 601 to rotate. The driving bevel gear 601 drives two driven bevel gears 602 in meshed connection to rotate, and the two driven bevel gears 602 drive the two driven screws 606 to rotate. During the rotation of the two driven screws 606, due to the limiting effect of the multiple limiting blocks 604 in the multiple limiting grooves 603, the upper plug-in bracket 302 with the internal threaded hole and the lower plug-in bracket 402 with the internal threaded hole move outward. During the rotation of the driving screw 608, due to the limiting effect of the multiple limiting blocks 604 in the multiple limiting grooves 603, the extrusion bracket 502 with the internal threaded hole moves downward on the driving screw 608 to drive the suction cup 503 to move downward until the suction cup can no longer move, that is, stopping when rotated to the limit position. In this case, the upper plug-in bracket 302 with the internal threaded hole and the lower plug-in bracket 402 with the internal threaded hole move out of the upper support arm 304 and the lower support arm 403, and the suction cup 503 adsorbs onto the ground.

Two lower support pipes 401 are inserted into the two lower connecting sleeves 202, and a lower support pipe A 401 is sleeved on the lower plug-in bracket 402 with the internal threaded hole of the main bracket A 303. Two upper support pipes 301 are inserted into the two upper connecting sleeves 102, and an upper support pipe A 301 is sleeved on the upper plug-in bracket 302 with the internal threaded hole of the main bracket 303 A.

The main brackets B, C and D 303 are placed on the ground and located at non-mounted ends of the two lower support pipes 401 and the two upper support pipes 301, respectively. The upper plug-in bracket 302 with the internal threaded hole and the lower plug-in bracket 402 with the internal threaded hole are inserted into the two lower support pipes 401 and the two upper support pipes 301 in the aforesaid manner to complete the mounting and adsorption.

An up-down overlapping arrangement of the upper 3D mesh fabric mattress 101 and the lower 3D mesh fabric mattress 201 can enhance overall support strength while maintaining excellent air permeability. In addition, the mattress assembly can be cleaned independently.

Although embodiments of the present disclosure have been shown and described, those of ordinary skill in the art may understand that many changes, modifications, substitutions and variations may be made to these embodiments without departing from the principles and purposes of the present disclosure, and the scope of the present disclosure is defined by the claims and their equivalents.

What is claimed is:

1. A 3D (Three-dimensional) mesh fabric pet bed with enhanced air permeability, comprising:
a first 3D mesh fabric mattress assembly, which is mounted on the topmost position to improve air permeability while enhancing support performance;
a second 3D mesh fabric mattress assembly, which is mounted below the first 3D mesh fabric mattress assembly and attached to the first 3D mesh fabric mattress assembly to enhance air permeability while cooperating with the first 3D mesh fabric mattress assembly for supporting; and
a bracket assembly, which is mounted between the first 3D mesh fabric mattress assembly, the second 3D mesh fabric mattress assembly and the ground and cooperate with the first 3D mesh fabric mattress assembly and the second 3D mesh fabric mattress assembly to form a pet bed, wherein
the bracket assembly comprises a first mattress mounting bracket assembly, a second mattress mounting bracket assembly, an adsorption assembly, and a synchronous drive assembly; the first mattress mounting bracket assembly is mounted between the first 3D mesh fabric mattress assembly and the ground, the second mattress mounting bracket assembly is mounted between the second 3D mesh fabric mattress assembly and the ground, the adsorption assembly is mounted on the ground, and the synchronous drive assembly is mounted between the first mattress mounting bracket assembly, the second mattress mounting bracket assembly, and the adsorption assembly to drive the first mattress mounting bracket assembly, the second mattress mounting bracket assembly, and the adsorption assembly to complete mounting and adsorption at the same time.

2. The 3D mesh fabric pet bed with enhanced air permeability according to claim 1, wherein the first 3D mesh fabric mattress assembly comprises an upper 3D mesh fabric mattress (101), upper connecting sleeves (102) are fixedly connected to both ends of the upper 3D mesh fabric mattress (101) by sewing, respectively, and the two upper connecting sleeves (102) are disposed symmetrically.

3. The 3D mesh fabric pet bed with enhanced air permeability according to claim 2, wherein the second 3D mesh fabric mattress assembly comprises a lower 3D mesh fabric mattress (201) disposed below the upper 3D mesh fabric mattress (101), lower connecting sleeves (202) are fixedly connected to both ends of the lower 3D mesh fabric mattress (201) by sewing, respectively, and the two lower connecting sleeves (202) are disposed symmetrically and perpendicular to the lower 3D mesh fabric mattress (201).

4. The 3D mesh fabric pet bed with enhanced air permeability according to claim 3, wherein the first mattress mounting bracket assembly comprises two upper support pipes (301) movably nested inside the two upper connecting sleeves (102) and four main brackets (303) disposed at both ends of the two upper support pipes (301), an upper support arm (304) is fixedly connected to an end wall, facing the upper support pipe (301), of the main bracket (303), an upper accommodating groove (305) communicating with the outside is formed in a side, facing the upper support pipe (301), of the upper support arm (304), and an upper plug-in bracket (302) that is provided with an internal threaded hole and inserted into the upper support pipe (301) is slidably disposed inside the upper accommodating groove (305).

5. The 3D mesh fabric pet bed with enhanced air permeability according to claim 4, wherein the second mattress mounting bracket assembly comprises two lower support pipes (401) movably nested inside the two lower connecting sleeves (202) and four lower support arms (403) fixedly connected to end walls, facing the lower support pipes (401), of the four main brackets (303), a lower accommodating groove (404) communicating with the outside is formed in a side, facing the lower support pipe (401), of the lower support arm (403), and a lower plug-in bracket (402) that is provided with an internal threaded hole and inserted into the lower support pipe (401) is slidably disposed inside the lower accommodating groove (404).

6. The 3D mesh fabric pet bed with enhanced air permeability according to claim 5, wherein the adsorption assembly comprises a support groove (501) formed in the main bracket (303), an extrusion bracket (502) with an internal threaded hole is disposed in the support groove (501), and a suction cup (503) is fixedly connected to a bottom end of the extrusion bracket (502) with the internal threaded hole.

7. The 3D mesh fabric pet bed with enhanced air permeability according to claim 6, wherein the synchronous drive assembly comprises a rotary knob (607) disposed on the main bracket (303), two drive grooves (605) respectively formed inside the upper support arm (304) and the lower support arm (403) on sides away from the upper accommodating groove (305) and the lower accommodating groove (404), and a plurality of limiting grooves (603) equidistantly formed along a circumferential direction on an inner sidewall that is of the upper support arm (304) and that faces the upper accommodating groove (305), an inner sidewall that is of the lower support arm (403) and that faces the lower accommodating groove (404), and an inner sidewall of the main bracket (303); a driving screw (608) is fixedly connected to a bottom end of the rotary knob (607), a bottom end of the driving screw (608) penetrates through the main bracket (303) to extend into the support groove (501) and to be rotatably connected to the main bracket (303); the driving screw (608) is fixedly sleeved with a driving bevel gear (601), and the bottom end of the driving screw (608) is threaded to the extrusion bracket (502) with the internal threaded hole; a driven screw (606) is disposed inside the drive groove (605), and an end wall, close to the driving bevel gear (601), of the driven screw (606) is fixedly sleeved with a driven bevel gear (602), and the driven bevel gear (602) meshes with the driving bevel gear (601); the other end of the driven screw (606) penetrates through the upper support arm (304) and the lower support arm (403) and then extends into the upper accommodating groove (305) and the lower accommodating groove (404) to be threaded to the upper plug-in bracket (302) with the internal threaded hole and the lower plug-in bracket (402) with the internal threaded hole; the driven screw (606) is rotatably connected to the upper support arm (304) and the lower support arm (403); and a limiting block (604) is movably embedded in the limiting groove (603), and a plurality of limiting blocks (604) are fixedly connected to the upper plug-in bracket (302) with the internal threaded hole, the lower plug-in bracket (402) with the internal threaded hole, and the extrusion bracket (502) with the internal threaded hole, respectively.

8. The 3D mesh fabric pet bed with enhanced air permeability according to claim 7, wherein end walls, away from the main bracket (303), of the upper support arm (304) and the lower support arm (403) are fixedly sleeved with limiting rings (701), respectively, and the limiting rings (701) abut against end walls of the upper connecting sleeve (102) and the lower connecting sleeve (202), respectively.
